(19) United States
(12) Patent Application Publication
(10) Pub. No.: US 2026/0058457 A1
(43) Pub. Date: Feb. 26, 2026

(54) ELECTRICAL ASSEMBLY

(71) Applicant: STÄUBLI ELECTRICAL CONNECTORS AG, Allschwil (CH)

(72) Inventors: Lee Michael WADE, Windsor, CA (US); Brian Wade MILLS, Santa Rosa, CA (US); Dustin Delmar Reede CARVER, Windsor, CA (US)

(73) Assignee: STÄUBLI ELECTRICAL CONNECTORS AG, Allschwil (CH)

(21) Appl. No.: 19/106,461

(22) PCT Filed: Aug. 22, 2023
(86) PCT No.: PCT/EP2023/072991

§ 371 Date: Feb. 25, 2025

Related U.S. Application Data
(60) Provisional application No. 63/401,333, filed on Aug. 26, 2022.
(60) Provisional application No. 63/401,313, filed on Aug. 26, 2022.

(51) Int. Cl. H02G 15/103

(52) U.S. Cl. CPC H02G 15/103

(57) ABSTRACT

Electrical assembly having a housing with an interior space, an electrical component that is arranged at least partly in the interior space, at least one cable having at least one wire to be electrically connected to the electrical component and an electrically isolating cable sheath encompassing the at least one wire, and at least one cable strain relief element. The at least one cable strain relief element is of u-shaped configuration with at least one base section from which two clamp sections extend, which clamp sections are arranged spaced apart from each other such that a clamping space is provided. The cable extends through the clamping space between the two clamp sections. At least one of the clamp sections is provided with at least one rib extending into the clamping space and protruding in the cable sheath.

### TECHNICAL FIELD

The present invention relates to an electrical assembly according to claim 1 and to a method to assemble said electrical assembly according to claim 21.

### PRIOR ART

From prior art electrical assemblies having strain relief elements which secure a cable to a housing are known. For example DE 200 18 199 U1 discloses such an assembly. A similar assembly is disclosed by GB 2 068 176.

### SUMMARY OF THE INVENTION

It is an object of the present invention to provide an electrical assembly which has an enhanced strain relief or which has an alternate strain relief.

This object is solved by the electrical assembly according to claim 1. Accordingly, an electrical assembly comprising a housing with a housing wall defining an interior space, an electrical component that is arranged at least partly in said interior space, at least one cable having at least one wire to be electrically connected to said electrical component and an electrically isolating cable sheath encompassing said at least one wire, and at least one cable strain relief element which is arranged in a reception area in said housing. The at least one cable strain relief element is of u-shaped configuration with at least one base section from which two clamp sections extend. The clamp sections are arranged spaced apart from each other such that a clamping space is provided. The cable extends through said clamping space between said two clamp sections. At least one of said clamp sections is provided with at least one rib extending into said clamping space and protruding in said cable sheath.

With the cable strain relief element that is located in said reception area a force acting on the cable can be absorbed by the cable strain relief element such that the force does not act onto the connection between the electrical component and the wire. The u-shaped or horseshoe shaped configuration of the clamp element and the at least one rib extending into the cable sheath enhances thereby the clamping effect between the cable and the cable strain relief element. This means in particular that higher forces can be compensated.

Given the u-shaped structure of the cable strain relief element, the cable strain relief element can be mounted perpendicular to middle axis of the cable.

The clamp sections are arranged at a distance to each other, whereby the distance defines the width of said clamping space.

Preferably, the housing and the cable strain relief element are made out of an electrically isolating material, such as plastic.

Preferably, the reception area is part of said interior space.

Preferably, the interior space is a cylindrical space having in particular a constant cross section over its whole length.

Preferably, said clamp sections extend from opposite sides of said base section.

Preferably, the cable strain relief element is contact with a stop surface. The stop surface can be part of the housing or it can be part of a further element such as the cable gland and/or the sealing element as mentioned below.

The term that the electrical component is arranged at least partly in said interior space is to be understood that the electrical component is arranged fully in said interior space or that it extends partly in said interior space and partly out of said interior space.

Preferably, both clamp sections comprise at least one rib, wherein the rib located on one of the clamp section is arranged displaced to the rib located on the other one of the clamp section as seen the cable, or along the middle axis of the cable, respectively. In other words:

The ribs are arranged on opposite sides of the cable.

The cable therefore meanders through the clamping space, which further enhances the clamping effect.

Preferably, one of said clamp sections comprises two ribs which are arranged at a distance to each other and wherein the other of said clamp sections comprises at least one or exactly one rib, which is arranged between said two ribs. Alternatively, one of said clamp sections comprises one rib or two ribs which are arranged at a distance to each other and wherein the other of said clamps sections is provided without a rib.

Concerning the orientation of the rib, it is preferably,
that at least one of said at least one rib extends perpendicular to the middle axis of the cable within the clamping space; and/or
that at least one of said at least one rib extends parallel to the middle axis of the cable within the clamping space; and/or
that at least one of said at least one rib extends with an angle, in particular between 1° and 90° angularly inclined to the middle axis of the cable within the clamping space.

Preferably, the base section is provided without a rib. This means that the base section is of flat configuration without any embossment structure. This structure has the advantage that the deformation of the cable can be limited to the degree which is really necessary to provide said clamping action.

Alternatively, the base section comprises at least one rib extending into said clamping space. In this configuration the clamping action can be enhanced.

Preferably, said at least one rib is tapered such that its cross section becomes smaller with increasing distance from said clamp section. The rib is provided as a wedge-like structure. The cross section is the cross section as seen perpendicular to the direction of the extension of the rib.

Preferably, the free end of said at least one rib extending into the clamping space is provided as a concave rounded edge; and/or wherein the free end of said rips are provided parallel to each other.

Preferably, said clamp sections have a free end opposite to the base section such that the clamping space is accessible between said clamp sections opposite to said base section.

Preferably, said free ends of said clamp sections and the clamp sections are provided such that an access opening is provided through which the cable is insertable into said clamping space.

The cable can be inserted in a direction perpendicular to the middle axis of the cable.

Preferably, the distance between said clamp sections is decreasing towards said base section such that width of the clamping space decreases towards the base section. This has the advantage the cable can be guided very easily into the clamp section.

Preferably, said clamp sections extend, as seen in direction of the middle axis of the cable within said space, substantially parallel to each other.

Preferably, said at least one cable strain relief element is a one-piece element that is provided separate from the housing.

Preferably, said reception area is provided as a cylindrical section and wherein said base section and said clamp sections, in particular with their free ends, are at least partially in contact with said cylindrical section.

Preferably, the free ends of the clamp sections are provided on the outer side with a concave rounded portion, which concave rounded portion preferably has the same radius as the cylindrical section.

Preferably, said base section has a concave rounded outer side which concave rounded outer side preferably has the same radius as the cylindrical section.

Preferably, the electrical assembly further comprises at least one cable gland which can be mounted to the housing by means of a snap-in connection.

Preferably, the electrical assembly further comprises at least one sealing element which encompasses and is in contact with said cable sheath and contacts a sealing surface of the housing.

Preferably, the cable gland and/or the sealing element have a stop surface which provides a stop for said cable strain relief element.

Preferably, said electrical component is a fuse element having a reception opening to receive said at least one wire. Alternatively, said electrical component is a socket-side or a plug-side of an electrical connector. In this embodiment the housing is preferably provided with respective mechanical interfaces such that an electrical connector can be provided.

Preferably, said housing comprises two reception areas which are arranged at opposite positions with regard to the interior space and wherein in each of the reception areas a cable strain relief element is located.

Preferably, said assembly comprises further two of said cables, which cables are electrically connected on opposing sides of said electrical component, and wherein said interior space preferably has a constant diameter between the reception areas such that one of said cables and the electrical component can be introduced in direction of one of said reception areas and wherein said cable can be fed through the interior space during an assembly process. Thereby the electrical component will be placed within the interior space.

Preferably, the cables are provided with electrical connectors on the side opposite to the electrical component.

Preferably, two of said cable glands and/or two of said sealing elements are arranged.

A Method to assemble said electrical assembly according to the description above, wherein said at least one cable strain relief element is mounted on the cable sheath, said at least one wire is electrically connected to said electrical component, said electrical component, said cable strain relief element and a part of said cable are inserted into the interior space.

In case the sealing element and/or the cable gland are present, the sealing element will also be place on the cable sheath and introduced into the interior space and the cable gland will be mounted to the housing.

Further embodiments of the invention are laid down in the dependent claims.

### BRIEF DESCRIPTION OF THE DRAWINGS

Preferred embodiments of the invention are described in the following with reference to the drawings, which are for the purpose of illustrating the present preferred embodiments of the invention and not for the purpose of limiting the same. In the drawings,

FIG. 1 shows a perspective partially exploded view of the electrical assembly according to one preferred embodiment;

FIG. 2 shows a detail of a perspective partially exploded view of the electrical assembly according to FIG. 1;

FIG. 3a-3d show different views of the cable strain relief element according to FIGS. 1 and 2;

FIG. 4a shows a cross-sectional view of the electrical assembly according to the previous figures;

FIG. 4b shows a detail of FIG. 4a;

FIG. 5 shows a perspective cross-sectional view of the electrical assembly according to the previous figures; and

FIG. 6 shows a further perspective view of the electrical assembly according to the previous figures with optional connectors.

### DESCRIPTION OF PREFERRED EMBODIMENTS

The figures show an electrical assembly 1 according to a preferred embodiment of the present invention.

The electrical assembly 1 comprises a housing 2, an electrical component 5, at least one cable 6 and a cable strain relief element 9. In the present embodiment two cables 6 and two cable strain relief elements 9, namely one per cable 6, are arranged.

The housing 2 comprises a housing wall 3 which defines an interior space 4. The interior space 4 is accessible through openings 26 at the front face of the housing 2. On the outer side the housing wall 3 comprises several stiffening ribs 27.

The at least one cable 6 has at least one wire 7 to be electrically connected to said electrical component 5. The at least one wire 7 is encompassed by an electrically isolating cable sheath 8.

The at least one cable strain relief element 9 is arranged in a reception area 10 in said housing 2 and is contact with the cable 6 or the cable sheath 8, respectively, as mentioned below.

The electrical component 5 is arranged in said interior space 4. The electrical component is, in the present embodiment, a fuse. The electrical component 5 can also be any other electrical component. In the present embodiment the electrical component 5 is in an electrical contact with the at least one wire 7 of said cables 6 on opposing sides.

The shown embodiment further comprises a cable gland 22 which can be mounted to the housing 2 by means of a snap-in connection. In the present embodiment two cable glands 22 are arranged. Furthermore, the electrical assembly further comprises a sealing element 23. In the present embodiment two sealing elements 23 are arranged. The sealing element 23 encompasses and is in contact with the cable sheath 8. Furthermore, the sealing element 23 contacts a sealing surface 24 of the housing 2. Preferably the sealing surface 24 of the housing is provided by the inner surface of the interior space 4. Preferably the interior space 4 is provided with a conical surface before the actual sealing surface 24 such that the insertion of the sealing element is enhanced. The diameter of the conical surface decreases with closer distance to the sealing surface 24.

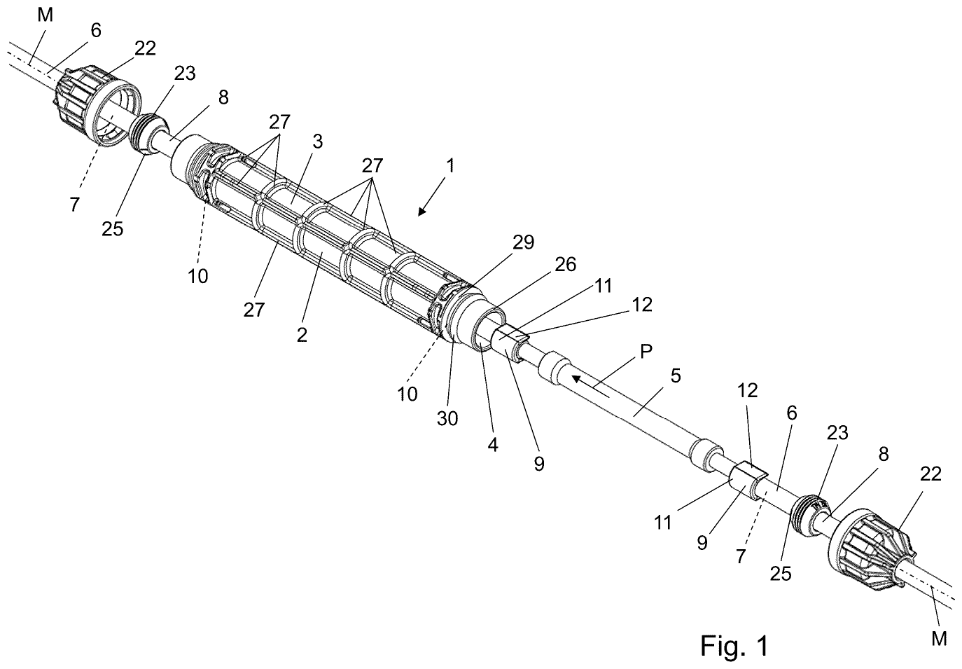

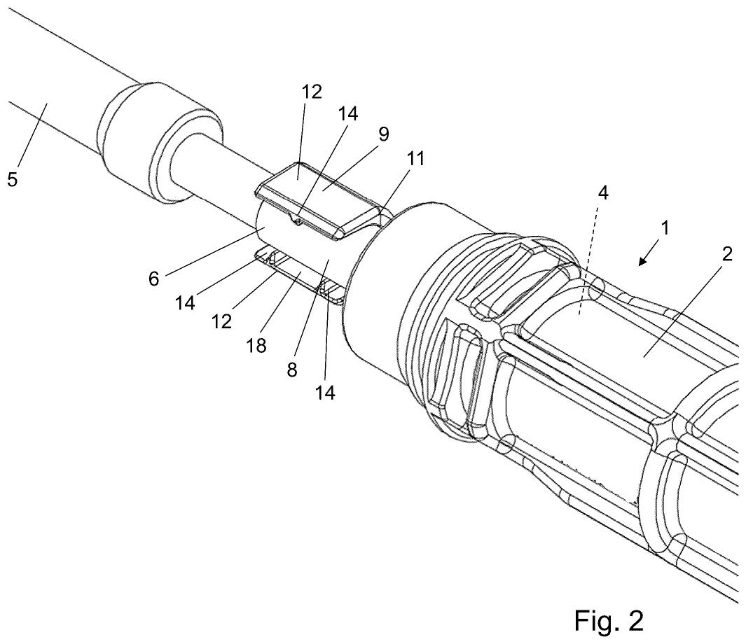

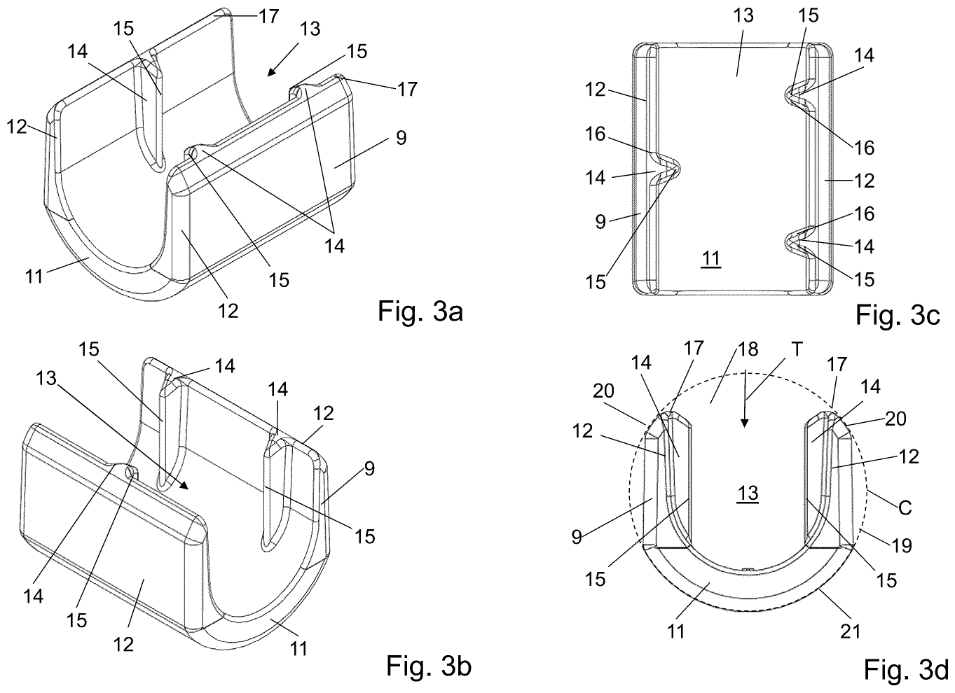

With reference to FIGS. 1, 2 and in particular to FIGS. 3a to 3d the structure of the cable strain relief element 9 is explained. The cable strain relief element 9 is of u-shaped configuration with a base section 11 from which two clamp sections 12 extend. The clamp sections 12 are arranged spaced apart from each other such that a clamping space 13 is provided. The cable 6 extends through said clamping space 13 between said two clamp sections 12. At least one of said clamp sections 12 is provided with at least one rib 14 extending in said clamping space 13 and protruding in said cable sheath 8. Thereby the cable 6 clamped within the clamping space 13 due to the interaction with said at least one rib 14.

In the embodiment shown, there are three ribs 14 arranged. Two ribs 14 are arranged on one of the clamp sections 12 and one rib 14 is arranged on the other one of the clamp sections 12. Thereby the two ribs 14 are spaced apart from each other and the one rib 14 is arranged opposite the clamping space 13 between said two ribs 14. Preferably the one rib 14 is arranged in the middle of said two ribs 14. This configuration has the advantage that the cable 6 meanders through the clamping space 13 and therefore the clamping action is enhanced.

The cable sheath 8 is preferably elastic and therefore the cable sheath 8 is slightly compressed in the region of the ribs 14 as the ribs 14 extend into the cable sheath 8.

In the present embodiment the base section 11 is provided without a rib. The base section 11 is provided as a flat surface.

The ribs 14 are tapered as it can be seen from FIG. 3c for example. Thereby the ribs 14 are tapered such that their cross section becomes smaller with increasing distance from said clamp section 12. In other words, the ribs 14 are provided in a wedge-like structure. The free end of the ribs 14 is here provided as a concave rounded edge. This has the advantage that the cable sheath 8 is not damaged when a force is applied onto the cable 6.

FIG. 3d shows that the free ends 15 of said rips 14 are oriented parallel to each other. Furthermore the clamp sections 12 are provided such that the distance between them is decreasing towards said base section 11. Therefore, the width of the clamping space 13 decreases towards the base section 11.

FIGS. 3a to 3d further show that the free ends 17 of the clamp sections 12 as well as the clamp sections 12 itself are provided such that an access opening 18 is provided. Through the access opening 18 the cable 6 is insertable into said clamp space 13. This is indicated in FIG. 3d by an arrow T.

The cable strain relief element 9 is a one-piece element that is provided separate from the housing 2. Preferably the cable strain relief element 9 is made out of plastic.

The reception area 10 is provided as a cylindrical section 19. In FIG. 3d the reception area is schematically shown by the circle C in broken lines. The cylindrical section 19 of the reception area 10 and the base section 11 as well as the clamp sections 12 are provided such that the base section 11 and the clamp sections 12, here with their free ends 17, are in a contact with the cylindrical section 19. In the present embodiment, the base section 11 has a concave rounded outer side 21 which has the same radius as the cylindrical section. Furthermore, the free ends 17 are also round in a concave manner.

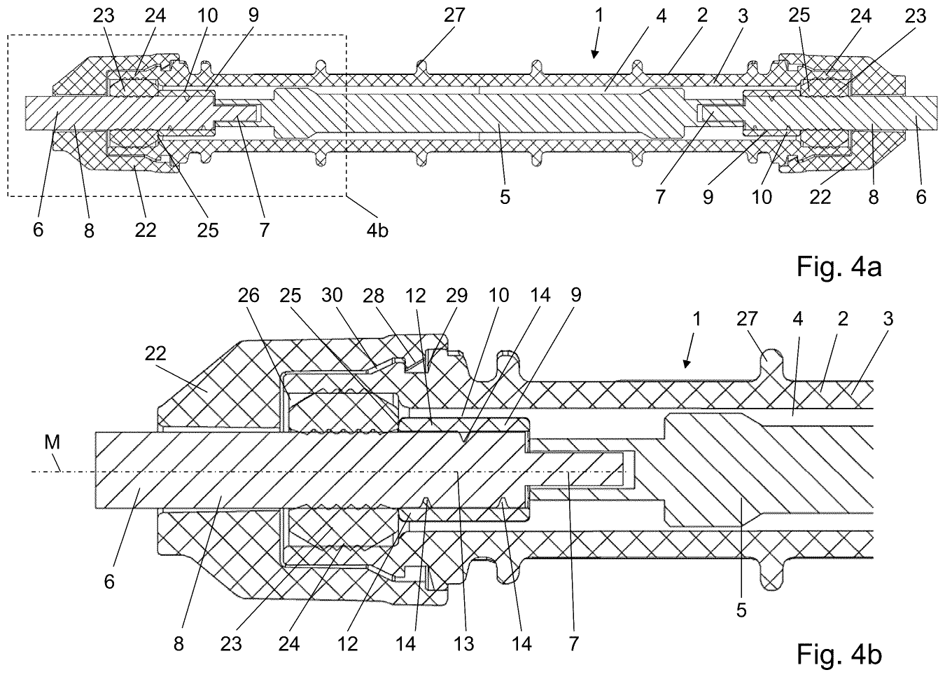

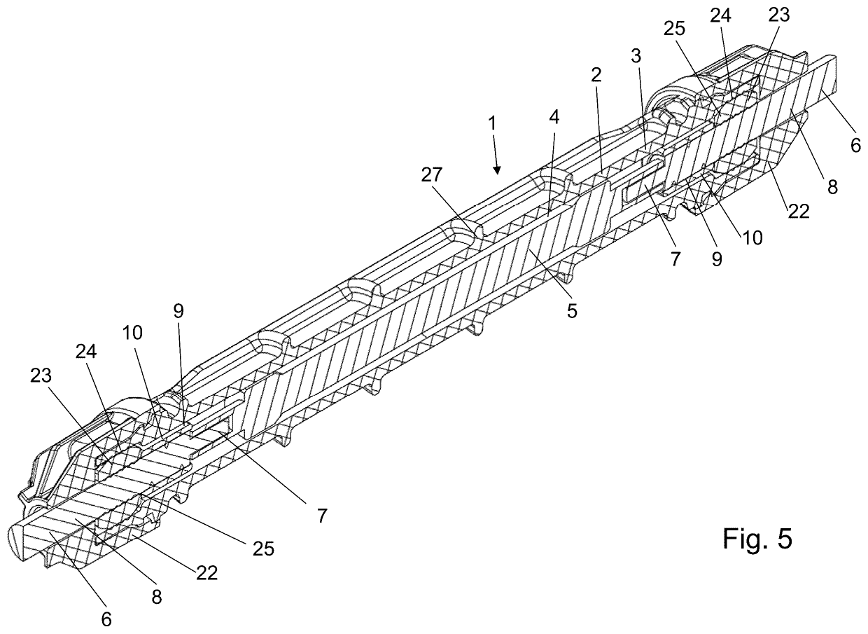

FIGS. 4a, 4b and 5 show a cross-sectional view. In the present embodiment, the cable strain relief element 9 is in contact with a stop surface 25. The stop surface 25 is provided by the sealing element 23. In case a force is acting on the cable 6, the cable strain relief element 9 will be held in its position by the stop surface 25.

From FIG. 4b the snap in connection between the cable gland 22 and the housing is shown. The snap in connection is provided by a cam 28 and by a groove 29 in which the cam 28 engages. The cam 28 is arranged on the cable gland 22 and the groove 29 is arranged on the housing 2. Before the groove 29 an angularly inclined surface 30 is arranged which supports the connection when the cable gland 22 is fitted to the housing 2. The cable gland 22 is provided such that the sealing element 23 is held within the interior space 4.

As mentioned above, the electrical component 5 is located between two cables 6 which are guided from opposite directions into the interior space 4. On either side a cable strain relief element 9, a sealing element 23 and a cable gland 22 is arranged. The electrical component 5 is located between the two cable strain relief elements 9.

With FIGS. 1, 4a and 5 the assembly process is illustrated. In a first step the at least one wire 7 of each cable 6 is electrically connected to the electrical component 5. Here two cables 6 are provided. Afterwards the cable strain relief element 9 is positioned on the cable sheath 8 at an appropriate position. Afterwards one of the cables is guided through the interior space 4 and the electrical component 5 as well as the cable strain relief elements 9 are inserted into the interior space 4 and the reception area 10. This is shown in FIG. 1 with an arrow P. Finally the sealing element 23 and the cable gland 22 are mounted on both sides.

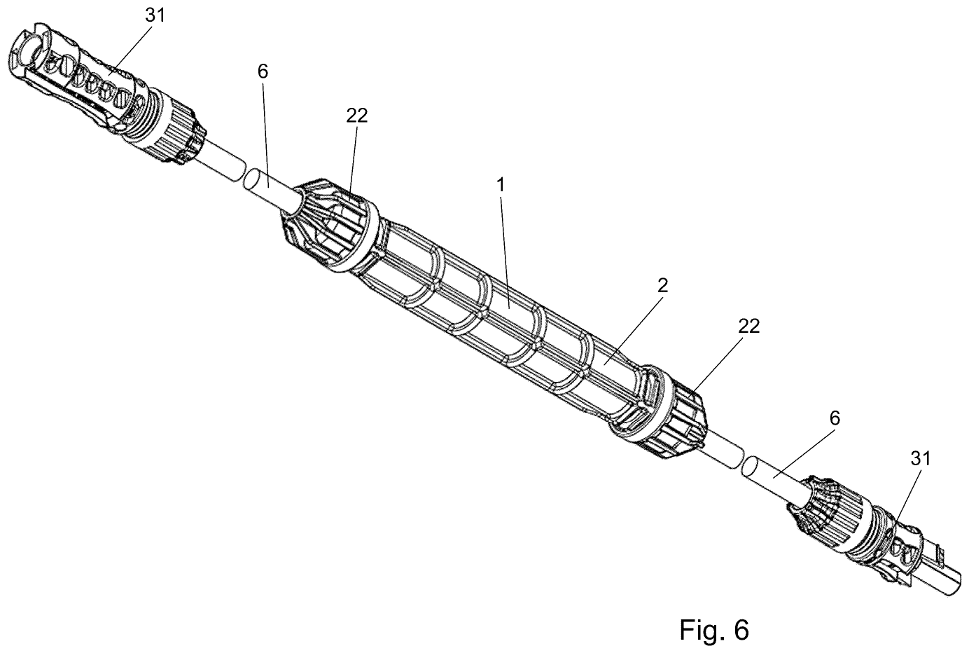

FIG. 6 shows the assembly as described above, whereby the end of the cables 6 are equipped with an electrical connector 31.

LIST OF REFERENCE SIGNS

| | |
|---|---|
| 1 | electrical assembly |
| 2 | housing |
| 3 | housing wall |
| 4 | interior space |
| 5 | electrical component |
| 6 | cable |
| 7 | wire |
| 8 | cable sheath |
| 9 | cable strain relief element |
| 10 | reception area |
| 11 | base section |
| 12 | clamp section |
| 13 | clamping space |
| 14 | rib |
| 15 | free end |
| 16 | concave rounded edge |
| 17 | free end |
| 18 | access opening |
| 19 | cylindrical section |
| 20 | concave rounded portion |
| 21 | concave rounded outer side |
| 22 | cable gland |
| 23 | sealing element |
| 24 | sealing surface |
| 25 | stop surface |
| 26 | opening |
| 27 | stiffening ribs |
| 28 | cam |
| 29 | groove |
| 30 | inclined surface |
| 31 | electrical connector |
| M | middle axis cable |
| C | circle |
| T | mounting direction |
| P | arrow |

1.-21. (canceled)

22. An electrical assembly comprising
a housing with a housing wall defining an interior space,
an electrical component that is arranged at least partly in said interior space,
at least one cable having at least one wire to be electrically connected to said electrical component and an electrically isolating cable sheath encompassing said at least one wire, and
at least one cable strain relief element which is arranged in a reception area in said housing,
wherein the at least one cable strain relief element is of u-shaped configuration with at least one base section from which two clamp sections extend, which clamp sections are arranged spaced apart from each other such that a clamping space is provided,
wherein the cable extends through said clamping space between said two clamp sections and
wherein at least one of said clamp sections is provided with at least one rib extending into said clamping space and protruding in said cable sheath.

23. The electrical assembly according to claim 22, wherein both clamp sections comprise at least one rib, wherein the rib located on one of the clamp section is arranged displaced to the rib located on the other one of the clamp section as seen along the cable.

24. The electrical assembly according to claim 22, wherein one of said clamp sections comprises two ribs which are arranged at a distance to each other and wherein the other of said clamp sections comprises at least one or exactly one rib, which is arranged between said two ribs; or wherein one of said clamp sections comprises one rib or two ribs which are arranged at a distance to each other and wherein the other of said clamps sections is provided without a rib.

25. The electrical assembly according to claim 22,
wherein at least one of said at least one rib extends perpendicular to the middle axis of the cable within the clamping space; and/or
wherein at least one of said at least one rib extends parallel to the middle axis of the cable within the clamping space; and/or
wherein at least one of said at least one rib extends with an angle, in particular between 1° and 90° angularly inclined to the middle axis of the cable within the clamping space.

26. The electrical assembly according to claim 22, wherein the base section is provided without a rib; or wherein the base section comprises at least one rib extending into said clamping space.

27. The electrical assembly according to claim 22, wherein said at least one rib is tapered such that the cross section becomes smaller with increasing distance from said clamp section.

28. The electrical assembly according to claim 22, wherein the free end of said at least one rib extending into the clamping space is provided as a concave rounded edge; and/or wherein the free end of said rips are provided parallel to each other.

29. The electrical assembly according to claim 22, wherein said clamp sections have a free end opposite to the base section such that the clamping space is accessible between said clamp sections opposite to said base section.

30. The electrical assembly according to claim 29, wherein said free ends of said clamp sections and the clamp sections are provided such that an access opening is provided through which the cable is insertable into said clamping space.

31. The electrical assembly according to claim 22, wherein the distance between said clamp sections is decreasing towards said base section such that width of the clamping space decreases towards the base section.

32. Electrical assembly according to claim 22, wherein said at least one cable strain relief element is a one-piece element that is provided separate from the housing.

33. The electrical assembly according to claim 22, wherein said reception area is provided as a cylindrical section and wherein said base section and said clamp sections, in particular with their free ends, are at least partially in contact with said cylindrical section.

34. The electrical assembly according to claim 33, wherein the free ends of the clamp sections are provided on the outer side with a concave rounded portion, which concave rounded portion preferably has the same radius as the cylindrical section; and/or
wherein said base section has a concave rounded outer side which concave rounded outer side preferably has the same radius as the cylindrical section.

35. The electrical assembly according to claim 22, wherein the electrical assembly further comprises at least one cable gland which can be mounted to the housing by means of a snap-in connection.

36. The electrical assembly according to claim 35, wherein the cable gland and/or the sealing element have a stop surface which provides a stop for said cable strain relief element.

37. The electrical assembly according to claim 22, wherein the electrical assembly further comprises at least one sealing element which encompasses and is in contact with said cable sheath and contacts a sealing surface of the housing.

38. The electrical assembly according to claim 37, wherein the cable gland and/or the sealing element have a stop surface which provides a stop for said cable strain relief element.

39. The electrical assembly according to claim 22, wherein said electrical component is a fuse element having a reception opening to receive said at least one wire; or wherein said electrical component is a plug-side or a pin-side of an electrical connector.

40. The electrical assembly according to claim 22, wherein said housing comprises two reception areas which are arranged at opposite positions with regard to the interior space and wherein in each of the reception areas a cable strain relief element is located.

41. The electrical assembly according to claim 40, wherein said assembly comprises further two of said cables, which cables are electrically connected on opposing sides of said electrical component, and wherein said interior space preferably has a constant diameter between the reception areas such that one of said cables and the electrical component can be introduced in direction of one of said reception areas and wherein said cable can be fed through the interior space during an assembly process.

42. The electrical assembly according to claim 14, wherein two of said cable glands and/or two of said sealing elements are arranged.

43. A method to assemble an electrical assembly comprising
a housing with a housing wall defining an interior space,
an electrical component that is arranged at least partly in said interior space,
at least one cable having at least one wire to be electrically connected to said electrical component and an electrically isolating cable sheath encompassing said at least one wire, and
at least one cable strain relief element which is arranged in a reception area in said housing,
wherein the at least one cable strain relief element is of u-shaped configuration with at least one base section from which two clamp sections extend, which clamp sections are arranged spaced apart from each other such that a clamping space is provided,
wherein the cable extends through said clamping space between said two clamp sections and
wherein at least one of said clamp sections is provided with at least one rib extending into said clamping space and protruding in said cable sheath,
wherein according to the method
said at least one cable strain relief element is mounted on the cable sheath,
said at least one wire is electrically connected to said electrical component,
said electrical component, said cable strain relief element and a part of said cable are inserted into the interior space.
